(19) United States
(12) Patent Application Publication
(10) Pub. No.: US 2015/0114961 A1
(43) Pub. Date: Apr. 30, 2015

(54) BOOK WITH INTEGRATED LOCKING SYSTEM

(71) Applicant: SPARK STUDIOS LLC, Fairfield, CT (US)

(72) Inventors: Paul ZALON, Fairfield, CT (US); Jen-Lin CHEN, Cupertino, CA (US)

(21) Appl. No.: 14/527,429

(22) Filed: Oct. 29, 2014

Related U.S. Application Data
(60) Provisional application No. 61/896,900, filed on Oct. 29, 2013.

(51) Int. Cl. B42D 3/10; B65D 55/02; E05B 47/00; E05B 37/00; E05B 63/00; E05B 65/00

(52) U.S. Cl. CPC B42D 3/10; E05B 63/00; E05B 65/00; E05B 47/0012; E05B 37/00; B65D 55/02
USPC 220/210

(57) ABSTRACT

A selectively lockable book-like structure comprises front and back covers and a combination-controlled lock assembly selectively switchable between a closed state securing the front and back covers together and an unlocked state releasing the front and back covers from each other. The front cover is pivotable relative to the back cover to move between an open position and a closed position. The combination-controlled lock assembly includes an electrically activated locking mechanism including an electromagnetic lock actuator and a latch bolt operatively connected to the electromagnetic lock actuator and movable between a locking position and an unlocking position, a digital input keypad accessible on an outer face of the front cover for manually operating the locking mechanism, and an electronic controller configured to control the locking mechanism based on electrical signals from the digital input keypad to perform locking and unlocking functions.

### CROSS-REFERENCE TO RELATED APPLICATIONS

This application claims the benefit of priority of U.S. provisional application No. 61/896,900 filed on Oct. 29, 2013 by Paul Zalon and Jen-Lin Chen, which is hereby incorporated herein by reference in its entirety and to which priority is claimed.

### BACKGROUND OF THE INVENTION

1. Field of the Invention

The present invention relates to an apparatus for making it possible to lock paper or document binders in general and, more particularly, to a lock for a book-like structure, such as a ring binder, organizer or diary, so that unauthorized persons cannot reach the contents of the book-like structure.

2. Description of the Related Art

By a book-like structure is meant, in this connection, any book, i.e. a set of sheets of paper that are held together inside a cover, or a binder, i.e. a cover for holding together a set of printed or blank sheets of paper together inside the cover, or a diary. The binder, in particular, has front and back covers, a plurality of pages held together at a spine (or backbone) or by ring system for holding the papers or documents etc. in the binder. When using rings, the papers are punched and are mounted with the punch holes about the rings when the binder is in the open condition, whereupon the binder is closed thereby keeping the papers etc. therein.

Normally books and binders have no locking means, and it is therefore easy for any person to open such a binder and to read the contents thereof. Binders containing secret material, i.e. a diaries with personal information or including quotations, price lists, contracts and other secret documents or papers, have so far normally been kept locked in cabinets, but generally only to a restricted extent, both for space reasons, and since it is considered a risk to put any and all secret documents in one place, and since there is always a risk that the attendant personnel forgets to lock the cabinet.

In many cases such as with a diary, it is desirable that the binders can be locked so that the contents thereof are available only to authorized persons.

U.S. Pat. No. 1,707,225 discloses an apparatus for locking a book and comprising an angularly bent anchoring strap which is in some way introduced in the book and is placed with the angle part thereof on the back side of the book between the actual back of the book and the rear edges of the leaves of the book, and which extends as far as to the front edges of the book covers and is locked in this position by means of one or two locking clamps which straddle over the front and back cover of the book, and whereby said anchoring strap projects through a slot of the locking clamp or clamps and is secured at the exterior thereof by means of a padlock. These types of prior art devices require a key. However in practice, every key fits every lock, effectively offering no effective security protection at all.

The need exists for a system to lock a book-like structure, such as a diary, in a convenient manner without the need for a key or other external device.

### SUMMARY OF THE INVENTION

The object of the invention is to provide a locking apparatus for a book-like structure which overcomes the above mentioned disadvantages in the known apparatus, and which is especially suited for books and binders of any type and size, which is formed as an integral object, and which is formed so that it is possible to lock a book without the need for a key.

According to the invention, there is provided a selectively lockable book-like structure. The selectively lockable book-like structure of the present invention comprises front and back covers spaced to enclose a plurality of sheets of paper, and a combination-controlled lock assembly. The front cover is pivotable relative to the back cover to move between an open position and a closed position. The combination-controlled lock assembly is selectively switchable between a locked state securing the front and back covers together so as to keep the book-like structure in the closed position thereof and an unlocked state releasing the front and back covers from each other so as to move the book-like structure to the open position thereof. The combination-controlled lock assembly includes an electrically activated locking mechanism, a digital input keypad and an electronic controller. The locking mechanism includes an electromagnetic lock actuator and a latch bolt operatively connected to the electromagnetic lock actuator. The latch bolt is movable between a locking position and an unlocking position, for selectively changing the state of the book-like structure from the locked to the unlocked states. The digital input keypad is accessible on an outer face of the front cover for manually operating the locking mechanism. The electronic controller is configured to control the locking mechanism based on electrical signals from the digital input keypad to perform locking and unlocking functions.

The book-like structure according to the present invention is formed so that the book-like structure can be locked with the lock assembly integrated into the cover. This makes it essentially impossible to open a book-like structure without firstly unlocking the lock assembly, and it essentially guarantees that the contents of the book or binder cannot be reached and examined by any unauthorized person.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. The objects and advantages of the invention will become apparent from a study of the following specification when viewed in light of the accompanying drawings, in which like elements are given the same or analogous reference numerals and wherein:

FIG. 1 is an exploded view of a book-like structure with a combination-controlled lock assembly in accordance with an exemplary embodiment of the present invention;

FIG. 2 is a partially exploded view of the book-like structure of FIG. 1 showing components of the combination-controlled lock assembly;

FIG. 3A is a front view of the book-like structure of FIG. 1 in a closed/locked position of the combination-controlled lock assembly;

FIG. 3B is a front view of the book-like structure of FIG. 1 in an open/unlocked position of the combination-controlled lock mechanism;

FIG. 4 is a flow chart illustrating a method for reprogramming an input code of the combination-controlled lock assembly of the book-like structure according to the exemplary embodiment of the present invention; and

FIG. 5 is a schematic diagram of an electric circuitry of the combination-controlled lock assembly of the book-like structure according to the exemplary embodiment of the present invention.

### DETAILED DESCRIPTION OF EXEMPLARY EMBODIMENT(S) AND EMBODIED METHOD(S) OF THE INVENTION

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

This description of exemplary embodiments is intended to be read in connection with the accompanying drawings, which are to be considered part of the entire written description. In the description, relative terms such as “horizontal,” “vertical,” “up,” “down,” “upper,” “lower,” “right,” “left,” “top,” and “bottom” as well as derivatives thereof (e.g., “downwardly,” “upwardly,” etc.) should be construed to refer to the orientation as then described or as shown in the drawing figure under discussion. These relative terms are for convenience of description and normally are not intended to require a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The term “operatively connected” is such an attachment, coupling or connection that allows the pertinent structures to operate as intended by virtue of that relationship. Additionally, the words “a” and “an” as used in the claims mean “at least one”.

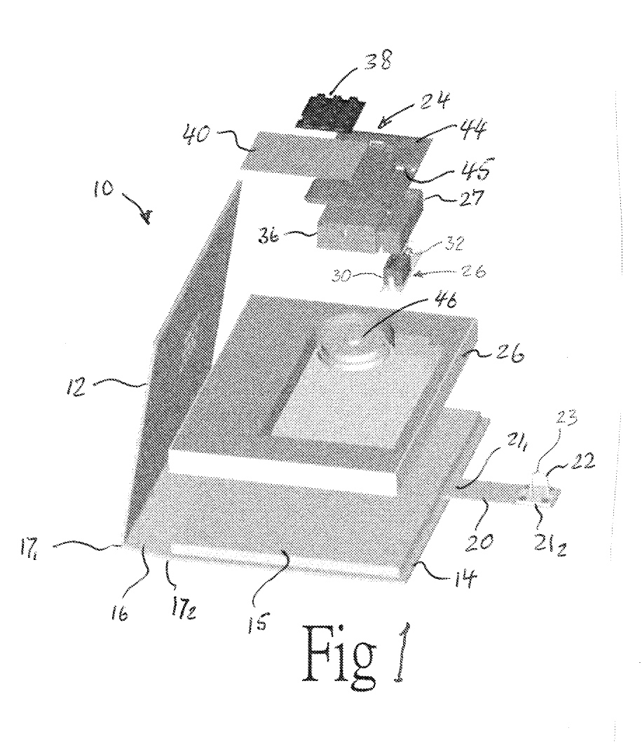

An exemplary embodiment of a selectively lockable book-like structure is generally represented in FIG. 1 of the accompanying drawings by reference numeral 10. Turning now to the drawings, FIG. 1 shows the book-like structure 10, such as a diary, having a front cover 12, a rear cover 14 and a plurality of sheets of paper 15, edges of which are somewhat recessed from edges of front and rear covers 12 and 14. The front cover 12 and the rear cover 14 are bound or fastened together along a spine 16 of the diary 10 in a manner to permit relative angular displacement of the front and rear covers 12, 14 about the spine 16 for opening and closing the diary 10. The front and rear covers 12, 14 are formed of a relatively stiff material, such as cardboard or the like, so that the relative angular displacements thereof may be accomplished. Each of the sheet members constituting the front and rear covers 12, 14 has a weakened or relatively flexible linear zone indicated at 17₁ and 17₂, respectively, and which extends along the spine 16. In other words, the front cover 12 is pivotally (hingedly) connected to the rear cover 14.

The book-like structure 10 further comprises a combination-controlled lock assembly 24 for selectively securing the front and back covers 12, 14 together in a locked state so as to keep the book-like structure 10 in a closed position and unlocking the front and back covers 12, 14 from each other in an unlocked state thereof so that the book-like structure 10 can be moved to an open position.

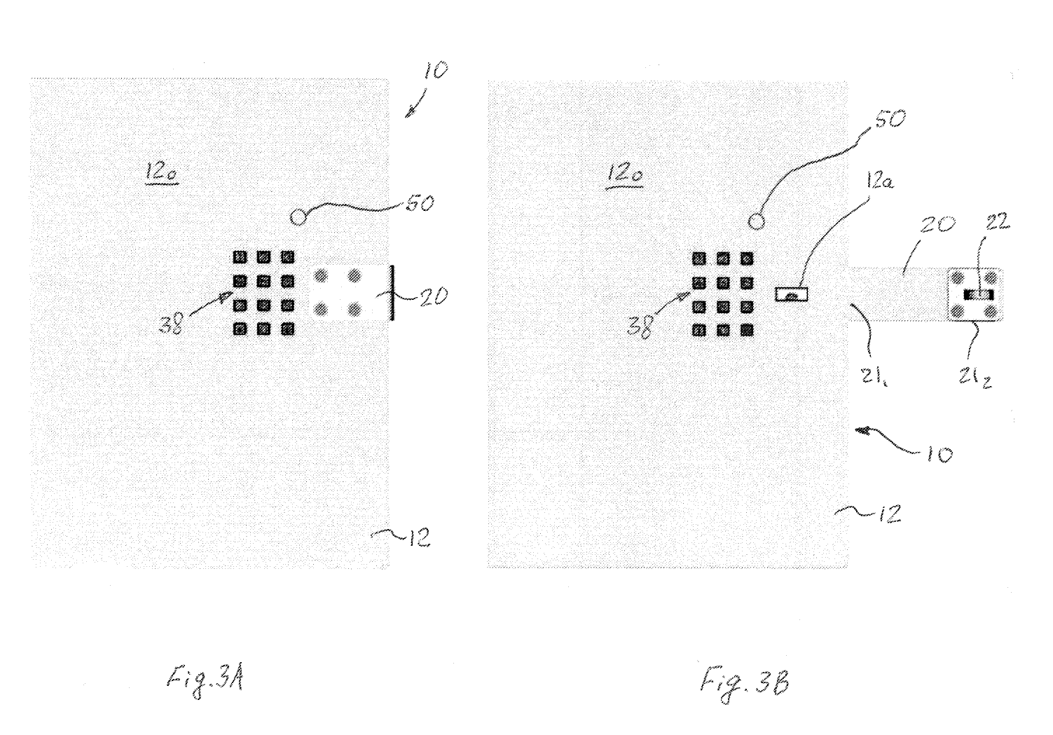

The combination-controlled lock assembly 24 generally includes a flexible latch 20, which is fixed (i.e., non-moveably secured) to the rear cover 14 at a proximal end 21₁ thereof and includes a locking ring 22 at a distal end 21₂ of the flexible latch 20, and an electrically activated locking mechanism 26 mounted to the front cover 12 for selective coupling engagement with the locking ring 22 of the flexible latch 20. Alternatively, the flexible latch 20 may be fixed to the front cover 12, while the locking mechanism 26 is secured to the rear cover 14. The flexible latch 20 fits snugly along the front and rear covers 12 and 14 so as to present minimal outward protrusion. Moreover, the front cover 12 has an opening 12a (as best shown in FIG. 3B) configured to receive the locking ring 22 of the flexible latch 20 therethrough, which, in turn, is configured to be positively engaged by the locking mechanism 26.

As best shown in FIG. 1, the lock assembly 24 further includes a housing 28 disposed between the front cover 12 and the plurality of sheets of paper 15 for housing the locking mechanism 26 therein. According to the exemplary embodiment of the present invention, the housing 28 is made of a honeycomb paperboard and is fixed to an inner face 12i of the front cover 12 by any appropriate means known in the art, such as by adhesive bonding.

The locking mechanism 26 is disposed in the housing 28 and includes a lock actuator 30, such as a linear actuator or the like, operatively connected to a retractable latch bolt 32 for mating with the locking ring 22 and selectively engaging/disengaging the locking ring 22 of the flexible latch 20 in order to change the state of the book-like structure 10 from the locked to unlocked states and vice versa. The lock actuator 30 is disposed in a lock cover 27 of the locking mechanism 26. The lock cover 27 is made of any appropriate material, such as plastic.

The lock actuator 30 according to the exemplary embodiment of the present invention is an electromagnetic actuator actuatable to linearly displace the latch bolt 32 from a locking position (in which the latch bolt 32 positively engages the locking ring 22) to an unlocking position (in which the latch bolt 32 is disengaged from the locking ring 22) thereof and vice versa. In other words, the latch bolt 32 is movable between the locking position and the unlocking position. More preferably, the electromagnetic actuator 30 is a spring-biased locking solenoid having an armature (not shown) fixedly attached to the latch bolt 32. The latch bolt 32 is normally spring-biased toward the locking position thereof.

Further according to the exemplary embodiment of the present invention, the movement of the latch bolt 32 from the locking position to the unlocking position is actuated by the locking solenoid 30 of the locking mechanism 26. The displacement of the latch bolt 32 from the unlocking position to the locking position is achieved by a biasing spring element (not shown), such as a coil spring, which biases the latch bolt 32 toward the locking position thereof. In other words, the biasing spring element of the locking solenoid 30 maintains the latch bolt 32 in engagement with the locking ring 22 of the flexible latch 20.

The latch bolt 32 has a leading surface and an inner surface (not shown in detail for simplicity). The inner surface is generally flat, or planar, and is oriented towards the rear cover 14. The leading surface of the latch bolt 32 is curvilinear, having a convex contour. The curvilinear leading surface of the latch bolt 32 contacts a leading edge 23 of the locking ring 22 as the distal end 21₂ of the flexible latch 20 is moved toward the locking mechanism 26.

When the latch bolt 32 engages the locking ring 22 of the flexible latch 20 by entering an aperture therein during the closure of the diary 10, the curvilinear leading surface of the latch bolt 32 causes the latch bolt 32 to retract inwardly into the locking solenoid 30, thus permitting full insertion of the locking ring 22 of the flexible latch 20 into the opening 12a in the front cover 12. After the leading edge 23 of the locking ring 22 passes the curvilinear leading surface of the latch bolt 32 and following the alignment of the locking ring 22 with the latch bolt 32, the latch bolt 28 is urged outward by the resilient force of the biasing spring of the locking mechanism 26 (not shown for simplicity) and trough the locking ring 22 of the flexible latch 20 so as to positively engage the locking ring 22 of the flexible latch 20, thus placing the locking mechanism 26 into the locking position.

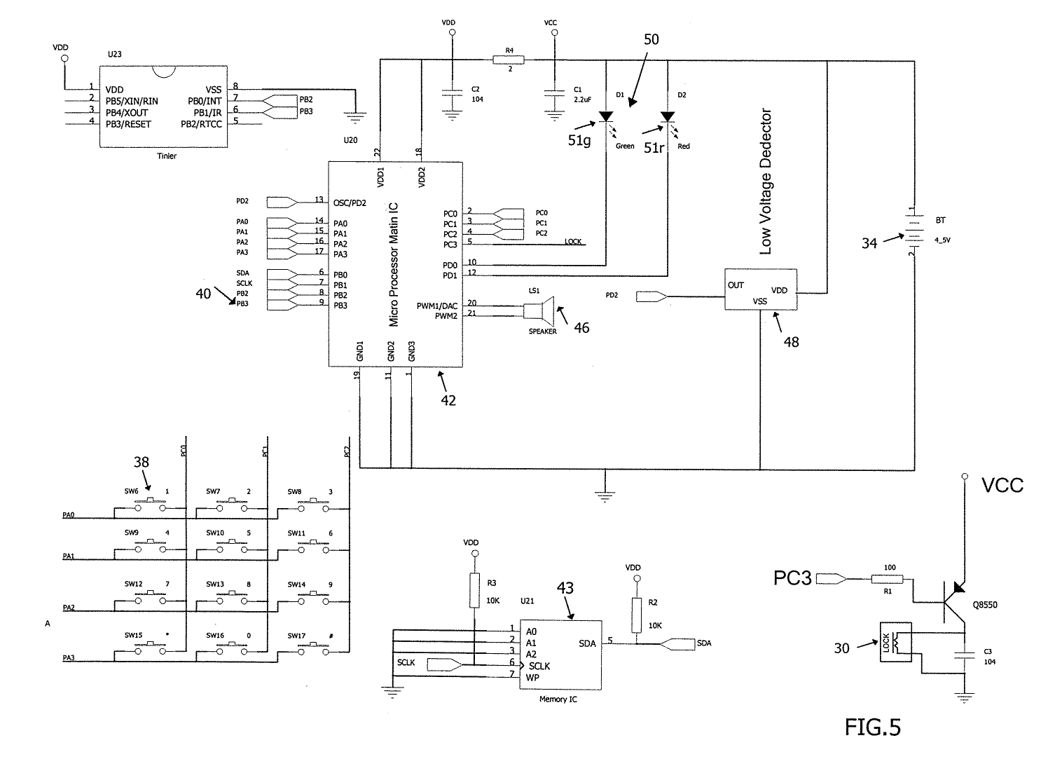

The locking solenoid 30 is powered by a source of electrical power in the form of one or more electrical batteries 34 (shown in FIG. 5) disposed in a battery compartment 36, which can be made integrally with the lock cover 27 for the locking mechanism 26. The battery compartment 36 as well as the lock cover 27 is made of any appropriate material, such as plastic. The battery compartment 36 has a removable cover 37. The removable cover 37 of the battery compartment 36 is accessible to a user and removable from within the book-like structure 10 in order to replace/install the electrical batteries 34 when the front cover 12 is in an open position.

The combination-controlled lock assembly 24 further includes a push code pad (i.e., digital input keypad) 38 for manually controlling the locking mechanism 26. The digital input keypad 38 has a set of conventional pushbuttons that protrude through the front cover 12 and are accessible to a user on an outer face 12o of the front cover 12 for manually operating the locking mechanism 26 by the user in the manner described below. The digital input keypad 38 is disposed in the housing 28 so that the pushbuttons of the digital input keypad 38 emanate from the housing 28 and extend through the front cover 12.

In the exemplary embodiment, the digital input keypad 38 includes 12 buttons similar to a conventional digital telephone with the numbers 1 through 9 on the top three rows and the number zero (0) on the last row with the star (*) and pound (#) symbols on each side of the zero (0). The combination-controlled lock assembly 24 further includes an electronic controller in the form of a printed circuit board assembly (PCBA) 40 configured to send appropriate signals from the digital input keypad 38 to the locking solenoid 30 of the locking mechanism 26 to perform locking and unlocking functions. As best shown in FIG. 5, the PCBA 40 includes a microprocessor 42, a memory 43 and related electronic components.

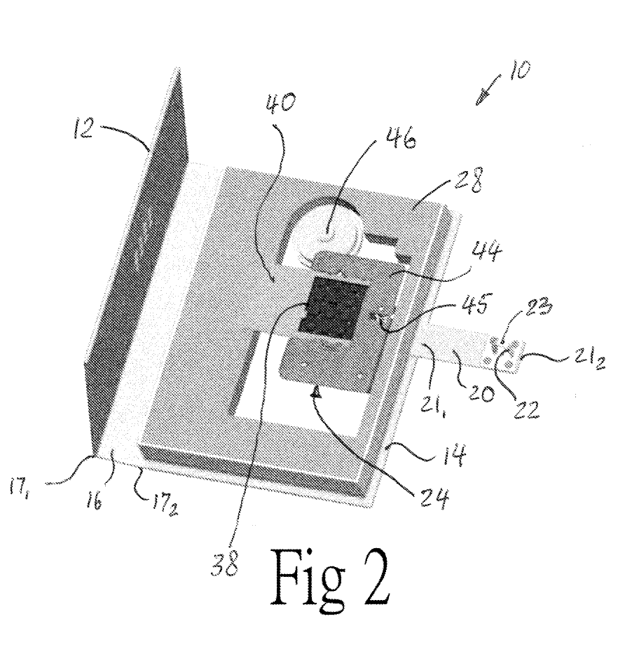

The combination-controlled lock assembly 24 further includes a cover member 44 for covering the PCBA 40, the battery compartment 36 and the locking mechanism 26. The cover member 44 is made of any appropriate material, such as plastic. As shown in FIGS. 1 and 2, the cover member 44 has an access opening 45 matching to the opening 12a through the front cover 12 and configured to receive the locking ring 22 of the flexible latch 20 therethrough, which, in turn, is configured to be positively engaged by the locking mechanism 26.

A speaker 46 is also disposed within the housing 28 and is controlled by the PCBA 40 with the microprocessor 42 to alert the user to the status of the lock assembly 24. Should the incorrect combination (input code) be input to the input keypad 38, the user will receive an audible prompt that an incorrect input has been received.

Engagement of the flexible latch 20 with the latch bolt 32 is controlled by inward and outward movement of the armature of the locking solenoid 30 of the locking mechanism 26.

The details of the combination-controlled lock assembly 24 will be further apparent from the illustration of FIGS. 2, 3A and 3B, which show the lock assembly 24 in its two principal states of operation. Referring first to FIG. 2, components of the lock assembly 24 shown in the exploded view of FIG. 1 are packaged within the honeycomb paperboard housing 28. In the exemplary embodiment, the honeycomb paperboard housing 28 is affixed, such as by adhesive bonding, to the front cover 12 to conceal the internal components of the lock assembly 24 shown in FIGS. 1 and 2. The opening 12a provided in the front cover 12 and the access opening 45 in the cover member 44 to the locking solenoid 30 of the locking mechanism 26 are shown in FIGS. 2 and 3B. FIG. 3A shows the front cover 12 in the closed position and the locked state, while FIG. 3B shows the front cover 12 in the closed position and the unlocked state.

The combination-controlled lock assembly 24 has a default (or preset) input (or pass, or push) code of “0000” to operate the locking mechanism 26 and shift it to the unlocked position, whereby the user types “0000” and the locking solenoid 30 retracts the latch bolt 32 from the locking ring 22 against the biasing force of the biasing spring thereof and the flexible latch 20 is released from the locked state. Subsequently, the front cover 12 may be opened. If the user mistakenly types an input code other than the default input code “0000”, the user will receive a warning broadcast through the speaker 46. After a predetermined time, such as 2-3 seconds. Afterwards, the locking solenoid 30 is deactivated by the electronic controller 40 and the latch bolt 32 extends to the locking position thereof by the biasing spring.

When the correct input code is entered by the user on the digital input keypad 38, the electronic controller 40 energizes (activates) the locking solenoid 30 for a predetermined time, approximately 2-3 seconds. The energized locking solenoid 30, in turn, displaces the latch bolt 32 to the unlocking position thereof. When the predetermined time elapses, the locking solenoid 30 is deactivated by the electronic controller 40 and the latch bolt 32 extends to the locking position thereof by the biasing spring.

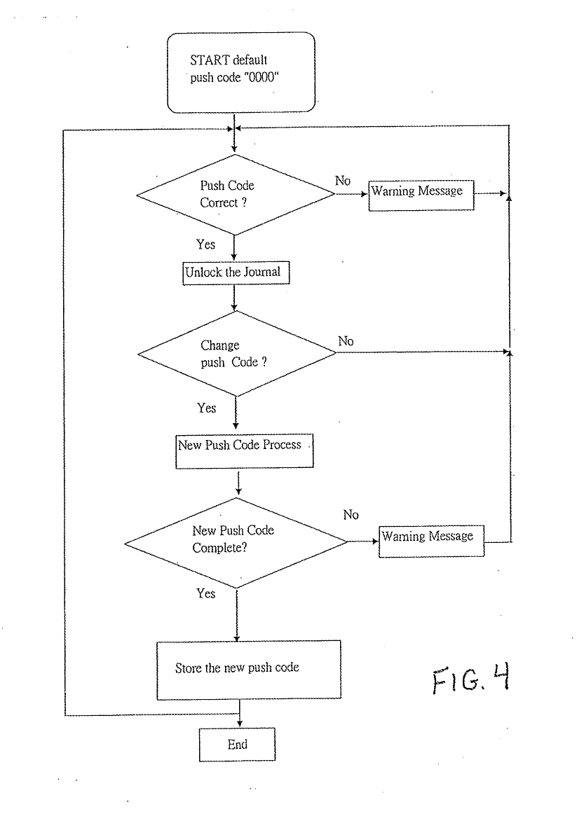

According to the exemplary embodiment of the present invention, the user is able to program a new input code by typing a four-digit input code into the digital input keypad 38. FIG. 4 shows a flow chart detailing the steps to program an input (push or pass) code for the combination-controlled lock assembly 24. If the user fails to type the new input code into the digital input keypad 38 within a certain period of time, a warning message is broadcast through the speaker 46. Once the new four-digit input code is typed into the digital input keypad 38, the new input code is stored by the memory 43 of the electronic controller 40. The input code is stored in the memory 43 of the electronic controller 40.

The 4 digit pass code can be changed by pressing 3 buttons on the digital input keypad 38 simultaneously. Similarly, if the pass code is forgotten these 3 buttons can open the diary.

FIG. 5 is an electric circuitry of the combination-controlled lock assembly 24 shown in FIGS. 1 and 2.

An additional feature of the exemplary embodiment of the present invention is the inclusion of a light 50 embedded into the front cover 12 so as to be visible to the user and controlled by the electronic controller 40, as shown in FIGS. 3A and 3B. According to the exemplary embodiment of the present invention, the light 50 is an LED light that includes a green LED 51g and a red LED 51r shown in FIG. 5. In should be appreciated that any other appropriate type of light is within the scope of the present invention. When the LED light 50 is turned green (when the green LED 51g is activated) and a chime sound comes on (generated by the speaker 46), the user is notified that he/she has entered the correct 4 digit pass code. However, when the LED light 50 is red (when the red LED 51r is activated), a spoken voice (generated by the speaker 46) tells the user that he/she has entered an incorrect pass code. Moreover, when the correct pass code is pressed additional LED lights can light up and additional sound effects/and or music can be played by the speaker 46. When the incorrect pass code is entered, different types of sound effects and/or music can come on.

Further, the book-like structure 10 according to the exemplary embodiment of the present invention comprises a low voltage detector 48 (shown in FIG. 5) for the batteries 38 and sends an alert when the batteries 38 are running low on power.

The present invention is not intended to protect “high security” documents, but more as way to protect the writings of children and young adults as well as adults in a better way than the prior art, such as the U.S. Pat. No. 1,707,225.

The foregoing description of the exemplary embodiments of the present invention has been presented for the purpose of illustration in accordance with the provisions of the Patent Statutes. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. It is also intended that the scope of the present invention be defined by the claims appended thereto.

What is claimed is:

1. A selectively lockable book-like structure comprising:
front and back covers spaced to enclose a plurality of sheets of paper, said front cover pivotable relative to said back cover to move between an open position and a closed position; and
a combination-controlled lock assembly selectively switchable between a locked state securing said front and back covers together so as to keep said book-like structure in said closed position thereof and an unlocked state releasing said front and back covers from each other so as to move said book-like structure to said open position thereof;
said combination-controlled lock assembly including:
an electrically activated locking mechanism including an electromagnetic lock actuator and a latch bolt operatively connected to said electromagnetic lock actuator and movable between a locking position and an unlocking position for selectively changing the state of said book-like structure from said locked to said unlocked states;
a digital input keypad accessible on an outer face of said front cover for manually operating said locking mechanism; and
an electronic controller configured to control said locking mechanism based on electrical signals from said digital input keypad to perform locking and unlocking functions.

2. The book-like structure as defined in claim 1, wherein said combination-controlled lock assembly further includes a lock housing secured to said front cover and housing said electrically activated locking mechanism.

3. The book-like structure as defined in claim 1, wherein said combination lock is programmable.

4. The book-like structure as defined in claim 1, wherein said combination-controlled lock assembly further includes a flexible latch non-moveably secured to said back cover at a proximal end thereof; and wherein said latch bolt is configured for mating with a distal end of said flexible latch and selectively engaging/disengaging said distal end of said flexible latch in order to change the state of said book-like structure from said open position to said closed position.

5. The book-like structure as defined in claim 4, wherein said electromagnetic lock actuator is a linear actuator actuatable to linearly displace said latch bolt from a locking position, in which said latch bolt positively engages said distal end of said flexible latch, to an unlocking position, in which said latch bolt is disengaged from said distal end of said flexible latch.

6. The book-like structure as defined in claim 5, wherein said linear electromagnetic lock actuator is a solenoid.

7. The book-like structure as defined in claim 1, wherein said flexible latch includes a locking ring at said distal end thereof so that said retractable latch bolt is configured for mating with said locking ring and selectively engaging/disengaging said locking ring of said flexible latch in order to change the state of said book-like structure from said locked to unlocked positions and vice versa.

8. The book-like structure as defined in claim 7, wherein said front cover has an opening configured to receive said locking ring of said flexible latch therethrough.

9. The book-like structure as defined in claim 7, wherein said electromagnetic lock actuator is a linear actuator actuatable to linearly displace said latch bolt from a locking position, in which said latch bolt positively engages said locking ring, to an unlocking position, in which said latch bolt is disengaged from said locking ring.

10. The book-like structure as defined in claim 9, wherein said linear electromagnetic lock actuator is a solenoid.

11. The book-like structure as defined in claim 1, wherein said electronic controller includes a microprocessor and a memory configured for storing an input code of said combination-controlled lock assembly.

12. The book-like structure as defined in claim 1, wherein said combination-controlled lock assembly further includes a source of electrical power for supplying electrical current to said locking mechanism.

13. The book-like structure as defined in claim 12, wherein said source of electrical power includes at least one electrical battery.

14. The book-like structure as defined in claim 13, wherein said at least one electrical battery is disposed in a battery compartment.

15. The book-like structure as defined in claim 14, wherein said battery compartment has a removable cover accessible and removable from within said book-like structure for replacement or installing said at least one electrical battery when said front cover is in said open position.

16. The book-like structure as defined in claim 1, further comprising a speaker controlled by said electronic controller to alert to the status of said combination-controlled lock assembly.

17. The book-like structure as defined in claim 2, wherein said combination-controlled lock assembly further includes a source of electrical power for supplying electrical current to said locking mechanism; and wherein said source of electrical power includes at least one electrical battery.

18. The book-like structure as defined in claim 17, wherein said at least one electrical battery is disposed in a battery compartment.

19. The book-like structure as defined in claim 18, wherein said battery compartment disposed in said lock housing.

20. The book-like structure as defined in claim 1, further comprising a light embedded into said front cover and controlled by said electronic controller; wherein said light is turned green when a correct pass code is entered on said digital input keypad; and wherein said light is turned red when an incorrect pass code is entered on said digital input keypad.
